(19) United States
(12) Patent Application Publication
(10) Pub. No.: US 2009/0238955 A1
(43) Pub. Date: Sep. 24, 2009

(54) PROCESSES FOR THE MANUFACTURE OF BARIUM TITANATE CAPACITORS ON NICKEL FOILS

(75) Inventors: Juan Carlos Figueroa, Wilmington, DE (US); Zhigang Rick Li, Hockessin, DE (US); Cengiz Ahmet Palanduz, Durham, NC (US); Damien Francis Reardon, Wilmington, DE (US); Lei Zhang, Hockessin, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/404,511

(22) Filed: Mar. 16, 2009

Related U.S. Application Data
(60) Provisional application No. 61/038,153, filed on Mar. 20, 2008.

(51) Int. Cl. B05D 5/12

(52) U.S. Cl. 427/79

(57) ABSTRACT

Provided are processes for the manufacture of capacitors. It is found that by using a nickel foil as the substrate and one electrode of the capacitor and by controlling the oxygen partial pressure in the range of 10⁻⁸ to 10⁻¹⁰ atmospheres during the crystallization heat treatment of the barium titanate, the leakage current can be maintained at adequate values without a reoxygenation step.

### FIELD OF THE INVENTION

The present invention relates to processes for the manufacture of capacitors.

### BACKGROUND

The manufacture of barium titanate capacitors by chemical solution deposition on metal foils previously required a reoxygenation step to reduce the leakage current in the dielectric.

U.S. Pat. No. 7,029,971 discloses a process for the production of barium titanate and doped barium titanate capacitors using chemical solution deposition and a reoxygenation step.

US 2007/0049026 discloses a process for the production of barium titanate capacitors using chemical solution deposition and a heat treatment in a reduced pressure environment.

The present invention provides processes using a nickel foil as a substrate for dielectric deposition and as one electrode of a capacitor. In the processes, the oxygen partial pressure is controlled in the range of 10⁻⁸ to 10⁻¹⁰ atmospheres during a crystallization heat treatment of barium titanate. The leakage current can be maintained at adequate values without a reoxygenation step.

### SUMMARY OF THE INVENTION

One aspect of the present invention is a process comprising:
a) providing a nickel foil as a first electrode;
b) depositing a solution of BaTiO₃ precursors to the nickel foil;
c) drying the solution;
d) decomposing the BaTiO₃ precursors to form amorphous BaTiO₃;
e) heating the amorphous BaTiO₃ to between 600° C. and 1200° C. in an atmosphere comprising a oxygen partial pressure between 10⁻⁸ and 10⁻¹⁰ atmospheres to form crystallized BaTiO₃; and
f) depositing a second electrode on the crystallized BaTiO₃ film.

### BRIEF DESCRIPTION OF THE FIGURES

FIG. 1 shows a flowchart of the process of the present invention.

FIG. 2 shows a diagram of a capacitor resulting from the process of the present invention

### DETAILED DESCRIPTION

Deposition of barium titanate dielectric thin film on a nickel foil to make a thin film capacitor with high capacitance can be achieved through a physical vapor deposition process of barium titanate or a chemical solution deposition process of barium and titanium precursors followed by controlled thermal processing. One contributing factor to high capacitance is the absence of NiO at the interface between the metal and the dielectric material deposited (BaTiO₃). Most materials will have a native oxide layer on the surface which contributes to lowering the capacitance of the device as described by the following equation of capacitors in series:

1/Cₜₒₜₐₗ=1/C₁+1/C₂+1/C₃+ . . . +1/Cₙ

where the total capacitance is dominated by the material with the lowest dielectric constant (NiO). By eliminating this undesired oxide, the capacitance will then be dominated by the deposited barium titanate dielectric material. The physical vapor deposition process which sputters barium titanate onto the metal foil is void of organics and is therefore susceptible to further oxidation at higher temperatures during the firing process.

It has been found by the present inventors that by using a nickel foil as a substrate for dielectric deposition and as one electrode of a capacitor, and by controlling the oxygen partial pressure in the range of 10⁻⁸ to 10⁻¹⁰ atmospheres during a crystallization heat treatment of the dielectric (barium titanate), the leakage current can be maintained at adequate values without a reoxygenation step. The formation of NiO can also be limited by intermediate firing of one or multiple layers by creating a barrier layer. Multiple layer deposition, drying, pre-firing and firing of one or multiple layer of the dielectric also provides a clean removal of the organic material from the dielectric and yields a dense film with low porosity and low organic impurities.

In a process for making a barium titanate capacitor by chemical solution deposition according to an embodiment of the present invention, precursor molecules are deposited onto the surface of a nickel foil. The precursor complexes of ligands chelated to barium and titanium are carried in a solvent. The solvent also carries any acceptor or donor dopant constituent to be included in the barium titanate dielectric material being made by the process. Suitable barium and titanium precursors include any compound containing an organic ligand and barium or titanium. Preferred barium and titanium (IV) precursors are of the type:

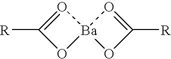

R is an alkyl group having 1 to 10 carbon atoms

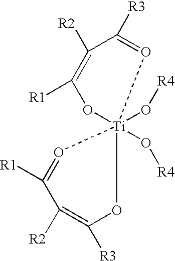

R1,R2,R3 can be H and/or an alkyl group having 1 to 10 carbon atoms
R4 is an alkyl group having 1 to 10 carbon atoms.

Suitable solvents for the deposition of these precursors include alcohols, carboxylic acids and mixtures of alcohols and carboxylic acids. Ethanol, butanol and isopropanol are preferred alcohols. Preferred carboxylic acids are acetic acid and propionic acid.

The surface of the nickel foil can be prepared to increase wetting of the surface by the subsequently applied barium titanate precursor formulation and maximize performance of the final capacitor device. Polycrystalline nickel foils are made up of small crystals called grains. Grains may range in size from several tens of nanometers to several hundred microns. The preparation includes annealing the nickel foil at low partial pressures of oxygen to increase the grain size of the nickel without further oxidation of the surface. It is then polished to a roughness of less than 10 nm. Finally the nickel surface is cleaned with a solvent.

In one embodiment of the process, a barium titanate precursor formulation is prepared as shown in the Examples. The formulation contains the precursor complexes and the solvent. The formulation can be applied to the nickel foil by any known coating technique, such as spray-coating, spin-coating, immersion, or brushing doctor blades. Once the formulation is coated on the foil, the solvent is removed through an evaporation process. This can be done by heating to temperatures of about 100° C. for a few minutes ranging from 1 to 60 minutes. Following the removal of the solvent from the deposited film, the organic ligands chelating the barium and titanium precursors are decomposed and/or removed. Decomposition or removal can be carried out by heating in air the coated nickel substrate to temperatures of 250° C. to 400° C. for about 1 to 60 minutes. It is desirable that the heating be carried out for as short a time as practical, to avoid oxidation of the nickel. The resulting deposit is amorphous barium titanate or an amorphous inorganic precursor to barium titanate, which may be doped with other constituents such as strontium, with Group II, Group III, transition metals or rare earths to achieve the desired dielectric properties and leakage current of the crystalline barium titanate. The dopant or dopants are added to the prescursor formulation and is applied to the nickel foil with the precursor formulation. Dopants may range in concentration from parts per billion up to about five percent on a weight basis.

It is preferred that the nickel foil not be exposed to temperatures above 400° C. for extended periods of time in air, because such exposure could lead to oxidation of the nickel. The resulting NiO formation could yield lower than desirable capacitance values. The transformation of the amorphous doped or non-doped barium titanate to the crystalline state on nickel foil is accelerated by heating to higher temperatures under low partial pressure of oxygen. It is found that heating the amorphous barium titanate to temperatures >550° C. under an atmosphere with a oxygen partial pressure of 10⁻⁸ or less for heating periods of 10 seconds to 1 hour, which is long enough to crystallize the barium titanate, reduces the oxidation of the nickel foil. However, heating the barium titanate in oxygen partial pressures less than 10⁻¹⁰ atmospheres can introduce defects into the barium titanate, which increase the leakage current of the dielectric, making the capacitor less desirable. The leakage current could be reduced by a reoxygenation heat treatment. However this requires an extra process step. An example of a crystallization heat treatment condition in which the reoxygenation treatment can be omitted is in an atmosphere of 10⁻⁸ to 10⁻¹⁰ atmospheres of oxygen at 750° C. or above for 1 to 60 minutes. Multiple layer deposition, drying, pre-firing and firing steps for one layer or multiple layers of the dielectric result in capacitors with capacitance densities in the range of 0.2 to 2 microfarad per centimeter squared and dissipation factors less than 7%. The presence of organic impurities and porosity would degradation the dielectric performance parameters, such as capacitance density and dissipation factor.

After the barium titanate or doped barium titanate dielectric is crystallized, the second electrode can be deposited on the dielectric. The second electrode is a conductor and may be copper, nickel, silver, gold or platinum. The second electrode may be sputtered or vapor deposited.

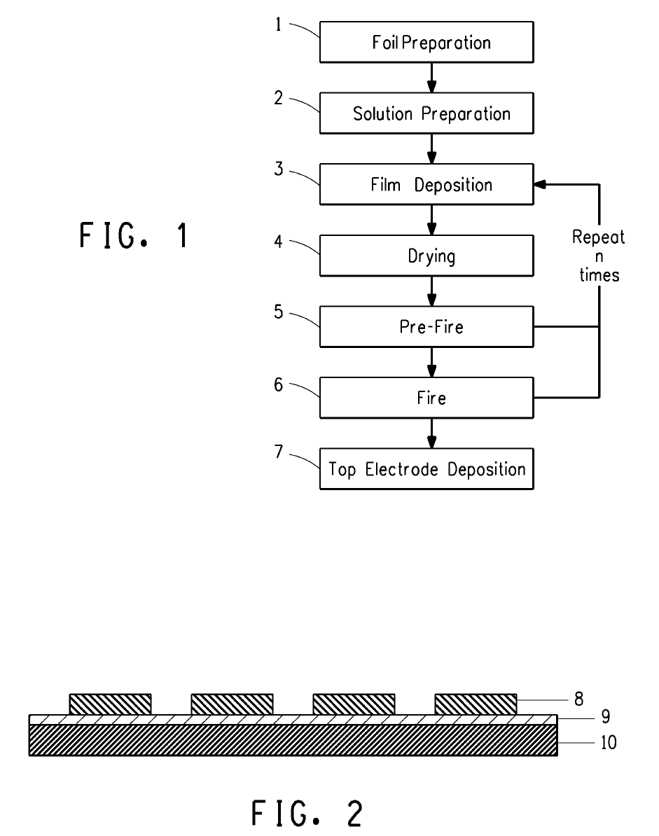

The flow chart in FIG. 1 illustrates one embodiment of a process used in the current invention. Box 1 of the flow chart indicates that in order to obtain a uniform coating of the barium titanate precursor formulation on the nickel foil the surface of the foil needs to be prepared to increase wetting of the surface and maximize performance of the final capacitor device. The nickel foil is annealed at low partial pressures of oxygen to grow the nickel grain without further oxidation. It is then polished to a roughness of less than 10 nm. Finally the nickel surface is cleaned through a solvent process by a series of washing steps with water, isopropanol and acetone.

Box 2 of FIG. 1 represents the barium chelate/titanium chelate formulation preparation before the thin film deposition.

The solution containing the precursor molecules and the solvent can be applied to the nickel foil by any known coating technique such as spray-coating, spin-coating, immersion, brushing doctor blades and the like as represented in box 3 of FIG. 1.

Once the solution is coated on the foil, the solvent is removed through an evaporation process. This can be done by heating to temperatures around 100° C. for a few minutes ranging between 1 and 60 minutes (FIG. 1, box 4). Following the de-solvation of the deposited film, the organic ligands chelating the barium and titanium precursors need to be decomposed/removed. This procedure is done by heating the coated nickel substrate to temperatures between 250° C. to 400° C. for a specified time period (between 1 and 60 min). The pre-firing step is represented by box 5 in FIG. 1. The resulting deposit is amorphous barium titanate or an amorphous inorganic precursor to barium titanate which may be doped with other constituents such as strontium, with Group II, Group III, transition metals or rare earths to achieve the desired dielectric properties and leakage current of the crystalline barium titanate. Exposure of the nickel foil to temperatures above 400° C. for extended periods of time in air would lead to oxidation of the nickel. The resulting NiO formation would yield lower capacitance values. At this stage, steps represented by boxes 3 through 5 can be repeated to build up a thick layer until the desired thickness is obtained. It is preferred that the firing step (box 6) be completed at least once before subsequent depositions (boxes 3 through 5). The firing of an initial barium titanate layer forms a barrier which protects the underlying nickel foil from oxidation. Multiple layers may be fired in one firing; however, the probability of nickel oxidation is higher.

The transformation of the amorphous doped or non-doped barium titanate to the crystalline state on nickel foil includes heating to higher temperatures under low partial pressure of oxygen as part of the firing step represented by box 6 in FIG. 1. It is found that heating the amorphous barium titanate to temperatures >550° C. under an atmosphere with a oxygen partial pressure of 10⁻⁸ or less reduces the oxidation of the nickel foil for heating periods of 10 seconds to 1 hour, which is long enough to crystallize the barium titanate. However, heating the barium titanate in oxygen partial pressures less than 10⁻¹⁰ atmospheres can introduce defects into the barium titanate which increase the leakage current of the dielectric, making the capacitor undesirable. The leakage current could be reduced by a reoxygenation heat treatment. However this requires an extra process step. The crystallization heat treatment conditions where the reoxygenation treatment can be omitted is in an atmosphere between 10⁻⁸ and 10⁻¹⁰ atmospheres of oxygen at 750° C. or above for 1 to 60 minutes. Multiple layer deposition, drying, pre-firing and firing steps for one or multiple layer of the dielectric also provides a clean removal of the organic material from the dielectric and yields a dense film with low porosity and low organic impurities.

After the barium titanate or doped barium titanate dielectric is crystallized, the second electrode can be deposited on the dielectric (box 7 of FIG. 1). The second electrode is a conductor and may be copper, nickel, silver, gold or Pt. The second electrode may be sputtered or vapor deposited.

FIG. 2 shows the final device as a result of the process described in the invention. The figure describes a thin film barium titanate dielectric layer that has been deposited in n layers and is sandwiched between two electrodes which on one side is a metal foil (Ni foil substrate) and on the other is a vapour deposited metal electrode. In FIG. 2, the top metal electrode is represented by 8, the barium titanate layer by 9 and the metal substrate or bottom electrode by 10. The complete structure represents the thin film capacitor device as a result of the process described in the invention.

### EXAMPLES

### Example 1

### One Firing of Multiple Layers

A precursor 0.3 M formulation containing [Ti] was prepared in the following manner:

25.5100 g (89.99 mmol) of anhydrous barium propionate (synthesized according to Hasenkox, U.; Hoffmann, S.; Waser R.; Journal of Sol-Gel Science and Technology, 1998, 12, 67-79.) was dissolved in a minimum amount of propionic acid (60.00 ml). To this solution, was added 35.3100 g of bis(acetylacetonato)bis(butoxo)titanium (89.99 moles). The solution was stirred and 1-butanol was added until the total volume of 300.00 ml was achieved.

A 50.8 micrometer thick Ni 201 foil (All Foils Inc.) was annealed at 1000° C. under an inert Ar atmosphere doped with 4% N₂/H₂ gas mixture for 1 h. The Ni foil was then polished (CMP) using a polymer resin polishing pad and a colloidal silica slurry to a roughness of <10 nm. The foil was then diced to size and cleaned sequentially with water, 2-propanol and acetone.

The barium/titanium formulation was filtered using a 0.45 micron PTFE filter.

The nickel substrate was spin-coated on a spin-coater with 0.7500 ml of filtered barium/titanium formulation at room temperature at 3000 rpm for 30 s in a clean room environment (class 100). The coated sample was then dried at 150° C. for 5 minutes and then at 400° C. for 15 minutes.

The spin-coating, drying, pre-firing cycle was repeated under the same conditions until the desired thickness was obtained.

The final layer was then fired to 850° C. for 30 minutes at a ramp rate of 8° C./s and a pO₂ of 4×10⁻⁹ atm using a vacuum chamber with an Ar bleed of 80 sccm. The pO₂ was monitered using a residual gas analyzer.

A 500 nm Cu top electrode was deposited via e-beam.

Final dielectric measurements yielded a functional capacitor with capacitance density ≦2.0 μF/cm² with a D_{f}≦0.07.

### Example 2

### Deposition of a Single Layer Which is then Fired, Followed by Deposition of Subsequent Layers Which are then Fired

A precursor 0.1 M formulation with respect to [Ti] was prepared in the following manner:

25.5100 g (89.99 mmol) of anhydrous barium propionate was dissolved in a minimum amount of propionic acid (60.00 ml). To this solution was added 35.3100 g of bis(acetylacetonato)bis(butoxo)titanium (89.99 mmoles) The solution was stirred and 1-butanol was added until the total volume of 900.00 ml was achieved.

A 50.8 micrometer thick Ni 201 foil (All Foils Inc.) was annealed at 1000° C. under an inert Ar atmosphere doped with 4% N₂/H₂ gas mixture for 1 h. The Ni foil was then polished (CMP) using a polymer resin polishing pad and a colloidal silica slurry to a roughness of <10 nm. The foil was then diced to size and cleaned sequentially with water, 2-propanol and acetone.

The barium/titanium formulation was filtered using a 0.45 micron PTFE filter.

The nickel substrate was spin-coated on a Cee 100 spin-coater with 0.7500 ml of filtered barium/titanium formulation at room temperature at 3000 rpm for 30 s in a clean room environment (class 100). The coated sample was then dried at 150° C. for 5 minutes and then at 400° C. for 15 minutes.

The first layer was then fired to 850° C. for 30 minutes at a ramp rate of 8° C./s and a pO₂ of 4×10⁻⁹ atm.

The coated nickel substrate was further spin-coated on a Cee 100 spin-coater with 0.7500 ml of a filtered 0.3M barium/titanium formulation (see example 1) at room temperature at 3000 rpm for 30 s in a clean room environment (class 100). The coated sample was then dried at 150° C. for 5 minutes and then at 400° C. for 15 minutes.

The spin-coating, drying, pre-firing cycle was repeated under the same conditions until the desired thickness was obtained.

The final build-up layers were then fired a second time at 850° C. for 30 minutes at a ramp rate of 8° C./s and a pO₂ of 4×10⁻⁹ atm.

A 500 nm Cu top electrode was deposited via e-beam.

Final dielectric measurements yielded a functional capacitor with capacitance density ≦2.0 μF/cm² with a D_{f}≦0.07.

### Example 3

### Multiple Firing Process

A 50.8 micrometer thick Ni 201 foil (All Foils Inc.) was annealed at 1000° C. under an inert Ar atmosphere doped with 4% N₂/H₂ gas mixture for 1 h. The Ni foil was then polished (CMP) using a polymer resin polishing pad and a colloidal silica slurry to a roughness of <10 nm. The foil was then diced to size and cleaned sequentially with water, 2-propanol and acetone.

The barium/titanium formulation was filtered using a 0.45 micron PTFE filter.

The nickel substrate was spin-coated on a spin-coater with 0.7500 ml of filtered 0.1M barium/titanium formulation at room temperature at 3000 rpm for 30 s in a clean room environment (class 100). The coated sample was then dried at 150° C. for 5 minutes and then at 400° C. for 15 minutes.

The first layer was then fired to 850° C. for 30 minutes at a ramp rate of 8° C./s and a pO₂ of 4×10⁻⁹ atm.

The coated nickel substrate was further spin-coated on a spin-coater with 0.7500 ml of filtered 0.3M barium/titanium formulation at room temperature at 3000 rpm for 30 s in a clean room environment (class 100). The coated sample was then dried at 150° C. for 5 minutes and then at 400° C. for 15 minutes.

The sample was then fired a second time at 850° C. for 30 minutes at a ramp rate of 8° C./s and a pO₂ of 4×10⁻⁹ atm.

The coating, drying, pre-firing, and firing steps were repeated until the desired thickness was achieved.

A 500 nm Cu top electrode was deposited via e-beam.

Final dielectric measurements yielded a functional capacitor with capacitance density ≦2.0 μF/cm² with a D_{f}≦0.07.

What is claimed:

1. A process comprising:
a) providing a nickel foil as a first electrode;
b) depositing a solution of BaTiO₃ precursors to the nickel foil;
c) drying the solution;
d) decomposing the BaTiO₃ precursors to form amorphous BaTiO₃;
e) heating the amorphous BaTiO₃ to between 600° C. and 1200° C. in an atmosphere comprising a oxygen partial pressure between 10⁻⁸ and 10⁻¹⁰ atmospheres to form a film of crystallized BaTiO₃; and
f) depositing a second electrode on the crystallized BaTiO₃ film.
